(19) United States
(12) Patent Application Publication
(10) Pub. No.: US 2017/0313210 A1
(43) Pub. Date: Nov. 2, 2017

(54) LOCKING MECHANISM FOR A BACKREST OF A VEHICLE

(71) Applicant: Grupo Antolin Ingeniería S.A., Burgo (ES)

(72) Inventor: Jorge GONZÁLEZ PÉREZ, Burgos (ES)

(21) Appl. No.: 15/495,287

(22) Filed: Apr. 24, 2017

(30) Foreign Application Priority Data
Apr. 27, 2016 (EP) 16382186

(51) Int. Cl. B60N 2/20; B60N 2/64

(52) U.S. Cl. CPC B60N 2/20; B60N 2/64

(57) ABSTRACT

A locking mechanism for a vehicle backrest includes a rotary latch engageable over a locking striker fixed to the vehicle, a detent pawl for locking the movement of the rotary latch in a locking position, and a leaf spring. The leaf spring includes two edges attached to the mechanism in first and second support points, and is placed in the mechanism such that, in the locking position, the striker is pushed by the leaf spring in one point of a contact area defined between first and second ends. The leaf spring further includes a central reinforced area and two exterior non-reinforced areas, wherein the reinforced area has smaller elastic deformation than the non-reinforced areas. A first edge of the reinforced area is placed between the first support point and first end, and a second edge of the reinforced area is placed between the second support point and second end.

### CROSS-REFERENCE TO RELATED APPLICATIONS

This application is related to and claims the benefit of European Patent Application No. 16382186, filed on Apr. 27, 2016, the contents of which are herein incorporated by reference in their entirety.

### TECHNICAL FIELD

The disclosure is related to locking mechanisms for vehicle seats, especially for locking the backrest of a rear seat to a vehicle structure.

### BACKGROUND

Locking mechanisms for vehicle seats must be able to block the position of the backrest to the structure of the vehicle but the locking force exerted by the mechanism must be no too strong to allow the closing of the mechanism and strong enough to prevent noises, especially rattle noises.

Conventional locking mechanisms for locking vehicle seats include:

a rotary latch for engaging over a striker fixed to the vehicle structure;
a detent pawl for locking the movement of the rotary latch establishing a locking position for the seat; and
a noise preventing mechanism for exerting a force upon the striker in the locking position.

A problem in the art is that the position between the striker and the locking mechanism varies due to mounting tolerances both of the striker and of the locking mechanism. When the noise preventing mechanism is a leaf spring, the mounting tolerances provoke little variations in the contact point of the striker upon the leaf spring but that little variations imply a great difference in the elastic deformation of the spring and consequently in the force exerted by the leaf spring upon the striker. Thus is difficult to control the locking force exerted by the mechanism during the closing of the mechanism and the prevention of rattle noises.

Locking mechanisms are disclosed for example in DE-3825594-A1, EP-0978606-B1, US-2012/0161455-A1 and GB-2212208-A.

### SUMMARY

The disclosure relates to a locking mechanism for a backrest of a vehicle seat (mountable on the backrest of the seat) comprising:

a rotary latch engageable over a locking striker fixed to the vehicle;

a detent pawl for locking the movement of the rotary latch in engagement over the locking striker in a locking position (locking position means that the backrest is placed substantially vertical and the locking mechanism is engaged over the striker such that the backrest cannot be folded onwards) and

a leaf spring comprising two mounting edges attached to the mechanism in a first support point and a second support point so that a working area (working area is an area where the spring can bend elastically through contact with the striker) is defined between the mounting edges. The leaf spring is placed or mounted in the mechanism such that in the locking position the striker is pushed by the leaf spring in one point of a contact area within the working area. The contact area is an area defined by all the possible positions of the contact point of the striker upon the spring and is delimited by a first end and second end.

The striker and the locking mechanism can be mounted on its respective positions (on the vehicle structure and backseat) with a maximum tolerance which defines the contact area for the leaf spring.

According to the disclosure, the leaf spring comprises a central reinforced area (delimited by a first edge and a second edge) and two exterior non-reinforced areas. The reinforced area has smaller elastic deformation than the non-reinforced areas. Preferably the deformation of the reinforced area is negligible with respect to the deformation on the non-reinforced areas, i.e. when the striker pushes against the reinforced area the elastic deformation of the spring (and the force exerted by the spring upon the striker) is only the deformation of the non-reinforced areas.

According to the disclosure, the first edge of the reinforced area is placed between the first support point and the first end of the contact area and the second edge of the reinforced area is placed between the second support point and the second end of the contact area. The contact area is within the reinforced area such that the leaf spring always pushes against the striker in a point within the reinforced area regardless the relative position of the striker and the locking mechanism. Thus the deformation of the leaf spring is always the same (the deformation of the non-reinforced areas) and the force exerted by the spring can be controlled.

In some embodiments of the disclosure, the reinforced area is longer than 15 mm and preferably longer than 20 mm.

In some embodiments of the disclosure, the reinforced area comprises a contact surface for the striker forming an angle between 80-100 degrees with respect to the relative movement direction between the striker and the locking mechanism during the locking operation. The force exerted by the leaf spring upon the striker is constant regardless the relative orientation between the striker and the locking mechanism. Preferably the contact surface is orthogonal to the relative movement direction.

In some embodiments of the disclosure the leaf spring comprises an additional part placed in the reinforced area. In some embodiments the additional part is a plastic part over-molded over the leaf spring in the reinforced area.

### BRIEF DESCRIPTION OF THE DRAWINGS

To complete the description and in order to provide for a better understanding of the disclosure, a set of drawings is provided. Said drawings form an integral part of the description and illustrate embodiments of the disclosure, which should not be interpreted as restricting the scope of the disclosure, but just as examples of how the disclosure can be carried out. The drawings comprise the following figures:

FIG. 1 is a top view of the mechanism in an unlocked position. The upper cap has been removed for clarity.

FIG. 2 is a top view of the mechanism in a locked position. The upper cap has been removed for clarity.

FIG. 3 is a top view of the mechanism. The detent pawl and rotary latch and the upper cap have been removed for clarity.

FIG. 4 is a perspective of the mechanism. The detent pawl, rotary latch and the upper cap have been removed for clarity.

### DETAILED DESCRIPTION OF THE DRAWINGS

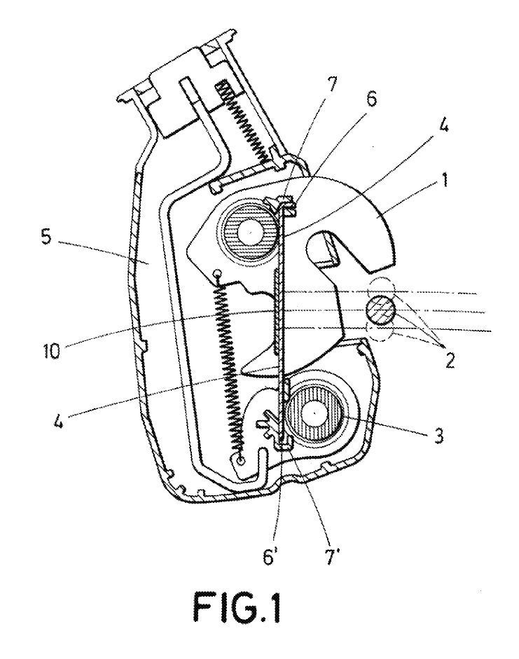

FIG. 1 illustrates a locking mechanism in an unlocked position, comprising a rotary latch 1, a detent pawl 3 and a leaf spring 4. A locking striker 2 attachable to the vehicle structure is also represented although the vehicle structure is not illustrated.

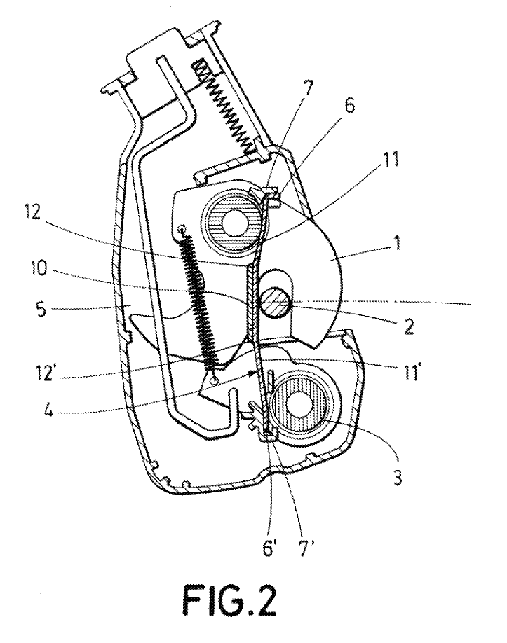

FIG. 2 illustrates a locking mechanism in a locking position, comprising a rotary latch 1 engaged over a locking striker 2, a detent pawl 3 locking the rotary latch 1 and a leaf spring 4 pushing upon the striker (2).

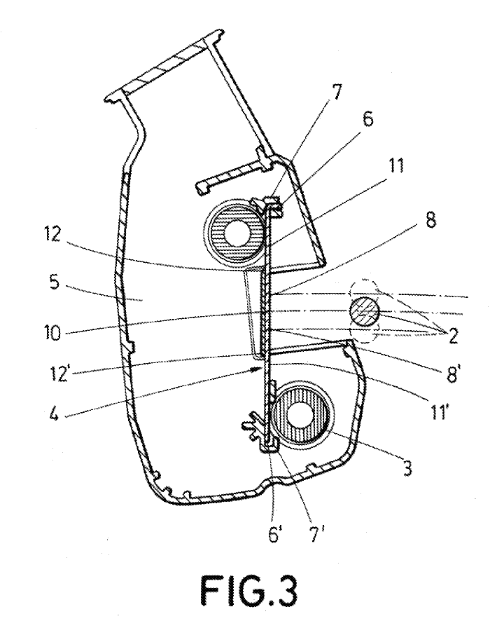

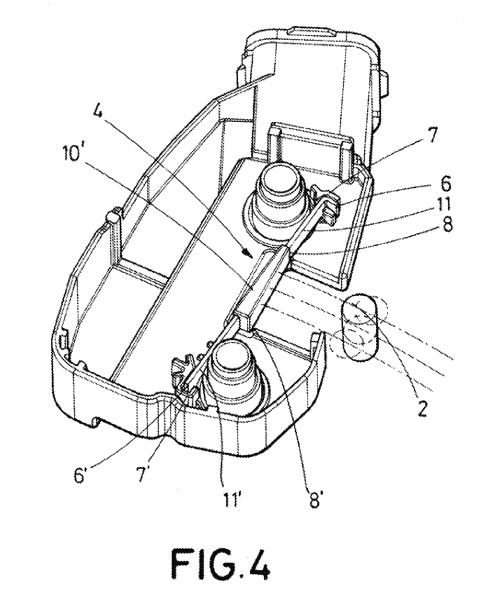

FIGS. 3 and 4 illustrate a locking mechanism in which the detent pawl 1 and rotary latch 3 have been removed for clarity. The upper cap has also been removed. The locking mechanism comprises a leaf spring 4 mounted on the support base 5 of the mechanism through its two mounting edges 6, 6′. The first mounting edge 6 is attached to a first support point 7 of the support base 5 and the second mounting edge 6′ is attached to a second support point 7′ of the support base 5. A working area for the leaf spring 4 is defined between the edges 6, 6′. That means that the leaf spring can deform elastically between the supporting points 7, 7′ when a force is applied.

As can be seen in FIG. 3 the leaf spring 4 is placed in the support base 5 such that, in the locking position, the striker 2 is pushed by the leaf spring 4 in one point of a contact area within the working area. FIG. 3 illustrates three possible positions of the striker 2 and the trajectories (in doted lines) that show the three different contacts points on the leaf spring 4. The different contacts points define a contact area on the leaf spring with a first end 8 and a second 8′ corresponding to the extreme positions of the contact area.

As can be seen in FIGS. 3 and 4 the leaf spring 4 comprises a central reinforced area 10 and two exterior non-reinforced areas 11, 11′. The reinforced area 10 has smaller elastic deformation than the non-reinforced areas 11, 11′ such that the contact against the striker 2 in any point of the contact area produces the same elastic deformation of the non-reinforced areas 11, 11′ and the deformation of the reinforced area 10 is practically negligible with respect to the non-reinforced areas 11, 11′. The force exerted by the leaf spring 4 in the three positions represented of the striker 2 is the same.

The reinforced area 10 comprises two edges 12, 12′. As illustrated in FIGS. 2 and 3 the first edge 12 of the reinforced area 10 is placed between the first support point 7 and the first end 8 of the contact area and the second edge 12′ of the reinforced area 10 is placed between the second support point 7′ and a second end 8′ of the contact area.

In an embodiment illustrated in FIG. 4 the reinforced area comprises a contact surface 13 for the striker 2 which is orthogonal to the relative movement direction between the striker 2 and the locking mechanism during the locking operation. In one embodiment the reinforced area 10 of the leaf spring 4 is an additional plastic part 10′ over-molded over the leaf spring 4.

In this text, the term “comprises” and its derivations (such as “comprising”, etc.) should not be understood in an excluding sense, that is, these terms should not be interpreted as excluding the possibility that what is described and defined may include further elements, steps, etc.

Unless otherwise indicated, any ranges referred to in this document include the indicated end points.

The disclosure is obviously not limited to the specific embodiment(s) described herein, but also encompasses any variations that may be considered by any person skilled in the art (for example, as regards the choice of materials, dimensions, components, configuration, etc.), within the general scope of the disclosure as defined in the claims.

1. A locking mechanism for a backrest of a vehicle comprising:
a rotary latch engageable over a locking striker fixed to the vehicle;
a detent pawl for locking the movement of the rotary latch in engagement over the locking striker in a locking position; and
a leaf spring comprising two edges attached to the mechanism in a first support point and a second support point so that a working area is defined between the support points; the leaf spring being placed in the mechanism such that, in the locking position, the striker is pushed by the leaf spring in one point of a contact area within the working area, the contact area being defined between a first end and a second end corresponding to limit positions of the contact point of the striker along the leaf spring (4); wherein the leaf spring comprises a central reinforced area and two exterior non-reinforced areas, the reinforced area having smaller elastic deformation than the non-reinforced areas and wherein a first edge of the reinforced area is placed between the first support point and the first end of the contact area and a second edge of the reinforced area is placed between the second support point and the second end of the contact area.

2. The locking mechanism as in claim 1, wherein the reinforced area is longer than 20 mm.

3. The blocking mechanism as in claim 1, wherein the reinforced area further includes a contact surface for the striker forming an angle between 80-100 degrees with respect to the relative movement direction between the striker and the locking mechanism during the locking operation.

4. The locking mechanism as in claim 1, wherein the reinforced area comprises a contact surface for the striker which is orthogonal to the relative movement direction between the striker and the locking mechanism during the locking operation.

5. The locking mechanism as in claim 1, wherein the leaf spring comprises an additional part placed in the reinforced area.

6. The locking mechanism as in claim 5, wherein the additional part is a plastic part over-molded over the leaf spring in the reinforced area.

7. A seat of a vehicle with a locking mechanism as recited in claim 6.
